(19) United States
(12) Patent Application Publication
(10) Pub. No.: US 2002/0170023 A1
(43) Pub. Date: Nov. 14, 2002

(54) Method and apparatus for supplying current to a semiconductor memory chip

(76) Inventors: Robert Kaiser, Kaufering (DE); Florian Schamberger, Bad Reichenhall (DE)

Correspondence Address: LERNER AND GREENBERG, P.A., Post Office Box 2480, Hollywood, FL, 33022-2480, US

(21) Appl. No.: 10/112,295

(22) Filed: Mar. 28, 2002

(30) Foreign Application Priority Data
Mar. 29, 2001 (DE) 101 15 614.6

(51) Int. Cl. G06F 17/50

(52) U.S. Cl. 716/4

(57) ABSTRACT

A method for supplying current to a semiconductor chip, particularly to a semiconductor memory chip, in which, in a standby mode, the semiconductor chip is supplied with current from a standby current generator, and in which, in a normal operating mode, the semiconductor chip is supplied with current from a normal mode current generator. The standby current generator provides a smaller current than the normal mode current generator, and where, in a product development phase, the semiconductor chip is supplied with current from the standby current generator in a test mode. The semiconductor chip is additionally to be supplied with current from the normal mode current generator in the product development phase.

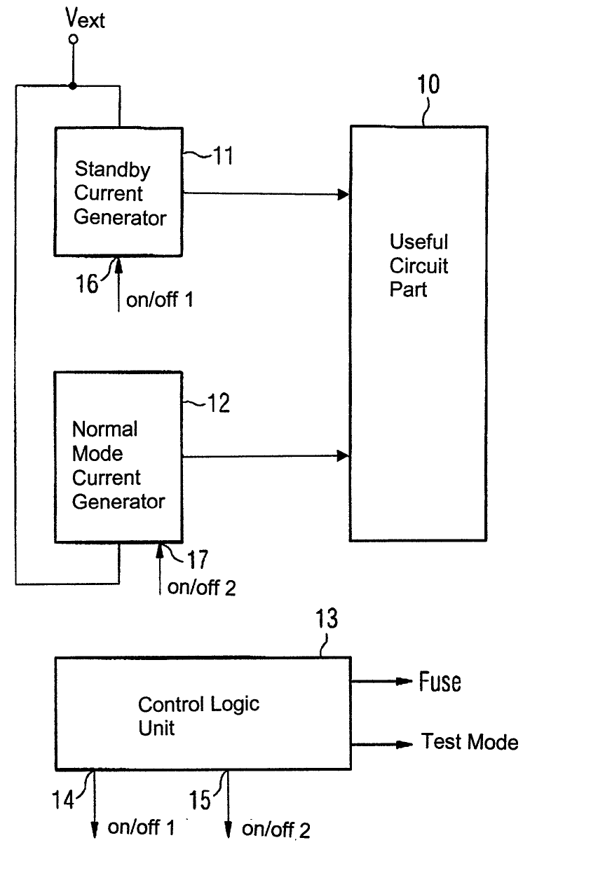

### BACKGROUND OF THE INVENTION

1. Field of the Invention

The invention relates to a method for supplying current to a semiconductor chip, particularly a semiconductor memory chip. In a standby mode, the semiconductor chip is supplied with current from a standby current generator, and in which, in a normal operating mode, the semiconductor chip is supplied with current from a normal mode current generator. The standby current generator provides a smaller current than the normal mode current generator, and where, in a product development phase, the semiconductor chip is supplied with current from the standby current generator for test purposes. The invention also relates to a semiconductor chip for carrying out the method.

Accordingly, the method provides two different current supply operating modes which are essentially distinguished by the provision of different levels of current, with less current naturally being required in the standby mode than in the normal operating mode. In the present case, the standby mode is understood to be an operating mode that covers both the standby mode and a power-down mode.

The supply of current from the standby current generator is also used for the purposes of analyzing the semiconductor memory chip. A problem in this respect is that a newly configured semiconductor chip can typically still have short circuits or undesirable cross current paths during the product development phase, and these can result in a collapse in the supply of current from the standby current generator, depending on the extent of the short circuit or the form of the cross current path. A consequence of this is that the short circuits and cross current paths cannot be ascertained by fault analysis during testing. Such semiconductor chips are therefore beyond specific fault analysis.

German Patent DE 40 07 187 C2 describes an integrated semiconductor circuit device having a device for producing a substrate voltage, whose voltage is altered in response to a test signal. This brings the integrated semiconductor circuit device back to just one area of malfunction in order to allow better assessment of the semiconductor circuit device in question.

### SUMMARY OF THE INVENTION

It is accordingly an object of the invention to provide a method and an apparatus for supplying current to a semiconductor memory chip which overcome the above-mentioned disadvantages of the prior art methods and devices of this general type, which allows fault analysis for short circuits and cross current paths in a product development phase even if the ability of the standby current generator to deliver current has been exhausted on account of these faults.

With the foregoing and other objects in view there is provided, in accordance with the invention, a method for supplying current to a semiconductor chip having a useful circuit, a standby mode current generator supplying a first current to the useful circuit, and a normal mode current generator supplying a second current to the useful circuit. The first current is smaller than the second current. The method includes the steps of carrying out a fault analysis on the useful circuit during a product development phase of a standby mode. The useful circuit is supplied with both the first current and the second current or only the second current. A test on the useful circuit is carried out during the product development phase of the standby mode. The useful circuit is supplied only with the first current from the standby mode current generator.

Accordingly, the method in question for supplying current to a semiconductor chip involves the useful circuit of the semiconductor chip additionally being supplied with current from the normal mode current generator in a product development phase. The inventive proposal is based on the insight that the normal mode current generator still delivers sufficient current even if the newly configured semiconductor chip still contains short circuits and/or undesirable cross current paths. The invention is thus based on the concept of, even during the product development phase, providing a powerful current source which does not collapse in the event go of short circuits and/or cross current paths in the newly configured semiconductor chip but rather continues, even in this unfavorable case, to deliver sufficient current to ensure fault analysis in the semiconductor chip.

The concept on which the invention is based also extends to the case in which, in the product development phase, the useful circuit of the semiconductor chip is supplied with current exclusively from the normal mode current generator, and hence in which the standby current generator is not activated in this case. In this case, the standby current generator is preferably used only for its original purpose of providing current for the semiconductor chip during the normal standby or power-down mode.

To ensure that, after the product development phase has concluded, the useful circuit of the semiconductor chip is supplied preferably only with the current from the standby current generator during normal operation of the standby mode, a switching device is activated after the product development phase has ended. In the standby mode, the useful circuit of the semiconductor chip can then be supplied with current from the normal current generator again only as a result of a specific test mode signal.

The invention also provides a semiconductor component, particularly a semiconductor memory component, whose useful circuit is supplied with current by the inventive method and which, to this end, has a standby current generator, a normal mode current generator and a control logic unit, where the control logic unit, according to the invention, activates the normal mode current generator in addition to the standby current generator in a product development phase. As an alternative to this, in the product development phase, it is also possible for only the normal mode current generator to be active, as referred to above in connection with the inventive method.

In addition, the semiconductor component configured in accordance with the invention is provided with a switching device in order to prevent the normal mode current generator from being activated together with the standby current generator after the product development phase has concluded, so that a normal standby mode is then available in which current is delivered exclusively from the standby current generator. The switching device is preferably in the form of a fuse (for example a fuse which can be melted by a laser).

Other features which are considered as characteristic for the invention are set forth in the appended claims.

Although the invention is illustrated and described herein as embodied in a method and an apparatus for supplying current to a semiconductor memory chip, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The single FIGURE of the drawing is a block diagram of a semiconductor chip according to the invention.

### DESCRIPTION OF THE PREFERRED EMBODIMENTS

Referring now to the single figure of the drawing in detail, there is shown schematically a semiconductor chip whose useful circuit 10 is supplied, in a standby mode, with current from a standby current generator 11 and, in a normal operating mode, with current from a normal mode current generator 12. A control logic unit 13 is provided for driving the standby current generator 11 and the normal mode current generator 12.

Both the standby current generator 11 and the normal mode current generator 12 are supplied with current or voltage from an external current or voltage source denoted by Vₑₓₜ in the figure.

A current delivery output of both the standby current generator 11 and the normal mode current generator 12 are (permanently) connected to the useful circuit 10. The control logic unit 13 contains a first control output 14 and a second control output 15. The first control output 14 is connected to a control input 16 on the standby current generator 11, while the second control output 15 is connected to a control input 17 on the normal mode current generator 12. The current outputs 14 and 15 carry turn-on/turn-off signals for the standby current generator 11 and for the normal mode current generator 12. Normal operation, i.e. operation in a mass produced semiconductor chip, involves current being supplied to the useful circuit 10 of the semiconductor chip which is in the standby mode exclusively from the standby current generator 11. For this purpose, a turn-on signal is available at the first control output 14 of the control logic unit 13 and at the control input 16 on the standby current generator 11, while a turn-off signal is available at the second control output 15 of the control logic unit 13 and at the control input 17 on the normal mode current generator 12. Hence, current is delivered to the useful circuit 10 exclusively from the standby current generator 11 via the connecting line that is relevant in this regard.

In the other case, namely during the normal operating mode, the signal switching situation is the opposite, i.e. a turn-off signal is available at the control output 14 of the control logic unit 13 and at the control input 16 on the standby current generator 11, while a turn-on signal is available at the second control output 15 of the control logic unit 13 and at the control input 17 on the normal mode current generator 12.

In addition, the control logic unit 13 is used to manage a test mode in a manner known per se in order to be able to subject a newly configured semiconductor chip to fault analysis in a product development phase. During the test mode, the useful circuit 10 of the newly configured semiconductor chip is supplied with current from the standby current generator 11, as during the standby mode in the prior art. The invention provides for the presence of a first test mode signal “0” to activate the normal mode current generator 12 in addition or as an alternative to the standby current generator 11 by making a turn-on signal available at the control output 15 of the control logic unit 13, which turn-on signal is applied to the control input 17 of the normal mode current generator 12 and activates the latter. This ensures that, even during the product development phase, when there may be faults in the semiconductor chip in the form of short circuits and/or cross current paths, there is always sufficient current delivered for the current source not to collapse and for fault analysis to be possible in all cases.

The tables below show the switching states of the normal mode current generator 12 and of the standby current generator 11 as a function of the state of the fuse and as a function of the test mode signal.

TABLE 1
Standby mode (Standby)

| | | Standby | Normal mode |
|---|---|---|---|
| | | current | current |
| Fuse | Test mode | generator | generator |
| (intact) 0 | 0 | on or off | on |
| (intact) 0 | 1 | On | off |
| (melted) 1 | 0 | On | off |
| (melted) 1 | 1 | On | on |

TABLE 2
smode (Active Mode)

| | | Standby | Normal mode |
|---|---|---|---|
| | | current | current |
| Fuse | Test mode | generator | generator |
| (intact) 0 | 0 | on or off | on |
| (intact) 0 | 1 | on or off | on |
| (melted) 1 | 0 | on or off | on |
| (melted) 1 | 1 | on or off | on |

Thus, according to the invention, there is always sufficient current provided for it to be possible to overcome even a short circuit and similar fault situations in the semiconductor chip such that fault analysis is still possible. This situation in which adequate current is delivered is, if appropriate, also ensured by virtue of current being provided exclusively from the normal mode current generator 12 during the product development phase, while the standby current generator 11 is inactive in this case, which is achieved by virtue of the presence of a first test mode signal “1” providing a turn-off signal at the control output 14 of the control logic unit 13, which turn-off signal is applied to the control input 16 on the standby current generator 11.

The inventive method is explained in more detail below with reference to the two tables above. The first table shows the switching states of the standby current generator 11 and of the normal mode current generator 12 in the standby mode. In this case, the first and second rows of the first table illustrate the supply of current to the useful circuit 10 in a product development phase for the semiconductor chip, where the fuse is still intact (value “0”). When a first test mode signal “0” is present, the useful circuit 10 of the semiconductor chip is supplied with current from the standby current generator 11 and from the normal mode current generator 12. This mode is used for carrying out fault analysis in the semiconductor chip. In this context, the supply of current to the useful circuit 10 is ensured despite any short circuits and cross current paths in the semiconductor chip. As an alternative to this, the useful circuit 10 of the semiconductor chip can also be supplied only with current from the more powerful normal mode current generator 12 in this mode, the less powerful standby current generator 11 then preferably being off.

The second row of the first table illustrates the supply of current to the useful circuit 10 of the semiconductor chip during a test in the product development phase which is carried out after the short circuits and cross current paths in the semiconductor chip have been eliminated with the fuse intact (value “0”). In this context, the operability of the semiconductor chip is tested under normal conditions of the standby mode. To this end, a second test mode signal “1” is applied to the semiconductor chip, and the useful circuit 10 of the semiconductor chip is then supplied only with current from the standby current generator 11. Only after the test has been passed is the fuse melted (value “1”).

The third and fourth rows of the first table show the supply of current to the useful circuit 10 of the semiconductor chip in the standby mode after the product development phase has concluded. In this context, as the third row shows, the useful circuit 10 is supplied only with current from the standby current generator 11 in the normal standby mode by applying the first test mode signal “0”. In contrast, the normal mode current generator 12 is off in this case.

For specific applications, however, the useful circuit 10 of the semiconductor chip can additionally be supplied with current from the normal mode current generator 12. In this context, the fourth row of the first table shows that, in the standby mode, when the second test mode signal “1” is present, both the standby current generator 11 and the normal mode current generator 12 are used for supplying current to the useful circuit 10 of the semiconductor chip in the standby operating mode.

The second table shows the switching states of the normal mode current generator 12 and of the standby current generator 11 in the normal operating mode of the semiconductor chip. In this case, the first and second rows of the second table, like in the first table, show the product development phase for the semiconductor chip, which is characterized by an intact fuse (value “0”). In contrast, the third and fourth rows of the second table show the switching states of the two current generators 11, 12 after the product development phase has concluded, when the fuse has melted (value “1”). As illustrated by the second table, the useful circuit 10 of the semiconductor chip is permanently supplied with current from the normal mode current generator 12, preferably regardless of the respective switching state of the fuse or of the value of the test mode signal, while the standby current generator 11 preferably remains off. Depending on the respective application, however, the standby current generator 11 can also be activated in addition to the normal mode current generator 12 in order, by way of example, to ensure the supply of current to the semiconductor chip even under extreme conditions.

We claim:

1. A method for supplying current to a semiconductor chip having a useful circuit, a standby mode current generator supplying a first current to the useful circuit, and a normal mode current generator supplying a second current to the useful circuit, the first current being smaller than the second current, which comprises the step of:
carrying out a fault analysis on the useful circuit during a product development phase of a standby mode, the useful circuit being supplied with one of both the first current and the second current and only the second current; and
carrying out a test on the useful circuit during the product development phase of the standby mode, the useful circuit being supplied only with the first current from the standby mode current generator.

2. The method according to claim 1, which comprises:
activating a switching device to supply the useful circuit permanently only with the first current from the standby mode current generator during a normal operation of the standby mode after the product development phase has ended.

3. The method according to claim 1, which comprises supplying the useful circuit with the second current from the normal mode current generator by activating a test mode during the standby mode after the product development phase has ended.

4. The method according to claim 1, which comprises during a normal operating mode of the semiconductor chip, supplying the useful circuit with one of both the first current and the second current and only the second current.

5. The method according to claim 1, which comprises using a semiconductor memory chip as the semiconductor chip.

6. A semiconductor component, comprising:
a useful circuit;
a standby current generator connected to and supplying said useful circuit with a first current;
a normal mode current generator connected to and supplying said useful circuit with a second current, said first current being smaller than said second current; and
a control logic unit connected to said standby current generator and to said normal mode current generator for changing over between a test mode and a normal mode, said control logic unit supplying said useful circuit, in a product development phase, with one of both the first current and the second current and only the second current in a standby mode for fault analysis, and for test purposes supplying just the first current.

7. The semiconductor component according to claim 6, further comprising a switching device to prevent activation of said normal mode current generator together with said standby current generator after the test mode has concluded.

8. The semiconductor component according to claim 7, wherein said switching device is a fuse.

9. The semiconductor component according to claim 6, wherein said semiconductor component is a semiconductor memory component.
